(19) United States
(12) Patent Application Publication
(10) Pub. No.: US 2019/0172045 A1
(43) Pub. Date: Jun. 6, 2019

(54) DYNAMIC GENERATION AND PROVISIONING OF TOKENIZED DATA TO NETWORK-CONNECTED DEVICES

(71) Applicant: The Toronto-Dominion Bank, Toronto (CA)

(72) Inventors: Milos Dunjic, Oakville (CA); Perry Aaron Jones Haldenby, Toronto (CA); Arthur Carroll Chow, Markham (CA); David Samuel Tax, Toronto (CA); John Jong-Suk Lee, Toronto (CA); Arun Victor Jagga, Toronto (CA)

(21) Appl. No.: 15/831,172

(22) Filed: Dec. 4, 2017

(51) Int. Cl. G06Q 20/32; H04L 29/08

(52) U.S. Cl. CPC G06Q 20/3224; G06N 3/02; H04L 67/18

(57) ABSTRACT

The disclosed embodiments include computer-implemented systems, apparatuses, and processes that dynamically generate and provision digital tokens to network-connected devices. For example, an apparatus receives a first signal that includes information identifying a current geographic location of a communications device. Based on the current geographic location, the apparatus computes an expected value of a parameter of a second data exchange during a future temporal interval, identifies a data type for use in the second data exchange based on the expected parameter value, and apparatus generates and transmits a second signal to a computing system associated with the identified data type. The second signal may include additional information instructing the computing system to provide, to the communications device, a digital token usable to initiate the second data exchange during the future temporal interval.

### FIELD

The disclosure relates to computer-implemented systems or processes that dynamically generate and provision tokenized data to network-connected devices.

### BACKGROUND

Today, payment systems and related technologies continuously evolve in response to advances in payment instruments, such as the ongoing transition from physical transaction cards to digital payment instruments maintained on mobile devices. These innovations result in additional mechanisms for submitting payment to an electronic or physical merchant and for flexibly funding transactions initiated by the electronic or physical merchant

### SUMMARY

In some example, an apparatus includes a communications unit, a storage unit storing instructions, and at least one processor coupled to the communications unit and the storage unit. The at least one processor is configured to execute the instructions to receive a first signal via the communications unit. The first signal includes first information identifying a current geographic location of a communications device, and based on the current geographic location, the at least one processor is further configured to execute the instructions to compute an expected value of a parameter of a second data exchange during a future temporal interval. The at least one processor is further configured to execute the instructions to identify a data type for use in the second data exchange based on the expected parameter value, and generate and transmit a second signal via the communications unit to a computing system associated with the identified data type. The second signal includes second information instructing the computing system to provide a digital token representative of the identified data type to the communications device, and the digital token is usable by the communications device to initiate the second data exchange during the future temporal interval.

In other examples, a computer-implemented method includes receiving, by at least one processor, a first signal via a communications unit. The first signal includes first information identifying a current geographic location of a communications device, and based on the current geographic location, the method also computes, by the at least one processor, an expected value of a parameter of a second data exchange during a future temporal interval. The method also includes identifying, by the at least one processor, a data type for use in the second data exchange based on the expected parameter value, and generating by the at least one processor and transmitting a second signal via the communications unit to a computing system associated with the identified data type. The second signal includes second information instructing the computing system to provide a digital token representative of the identified data type to the communications device, and the digital token is usable by the communications device to initiate the second data exchange during the future temporal interval.

Further, in some examples, a tangible, non-transitory computer-readable medium stored instructions that, when executed by at least one processor, performs a method. The method includes receiving a first signal via a communications unit. The first signal includes first information identifying a current geographic location of a communications device, and based on the current geographic location, the method also computes an expected value of a parameter of a second data exchange during a future temporal interval. The method also includes identifying a data type for use in the second data exchange based on the expected parameter value, and generating and transmitting a second signal via the communications unit to a computing system associated with the identified data type. The second signal includes second information instructing the computing system to provide a digital token representative of the identified data type to the communications device, and the digital token is usable by the communications device to initiate the second data exchange during the future temporal interval.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment, consistent with disclosed embodiments.

FIGS. 2A, 2B, 3A, and 3B are diagrams illustrating portions of an exemplary computing environment, consistent with the disclosed embodiments.

FIG. 4 is a flowchart of exemplary processes for dynamically generating and provisioning tokenized data to network-connected devices, consistent with disclosed embodiments.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the described subject matter.

This specification describes exemplary computer-implemented apparatuses, devices, systems, and processes that, among other things, perform operations that initiate, approve, and execute exchanges of data between network-connected devices and systems operating in a computing environment. Further, and as described herein, these exemplary apparatus, devices, systems, and process can also perform operations that determine a value of one or more parameters characterizing a predicted future occurrence of a data exchange, and that dynamically generate tokenized data facilitating an initiation of the data exchange by a network-connected device. The exemplary apparatus, devices, systems, and process described herein may perform additional operations that provision the tokenized data to the network-connected device through a corresponding programmatic interface prior to the predicted future occurrence of the data exchange and without intervention from a user operating the network-connected devices.

In one example, and as described herein, a computing system operating within the computing environment may receive a signal that includes information identifying a current geographic location of a client device. The signal may, in some instances, be generated by an application program executed by the client device (e.g., based on information output by a corresponding positioning unit or sensor, such as a GPS unit), and the executed application program may cause the client device to transmit the generated signal to the computing system at predetermined temporal intervals, and additionally or alternatively, in response to a detection of a predetermined triggering event (e.g., a change in an operation mode of the communications device) or in response to a request received from the computing system.

In response to the received signal, the computing system may load, from a storage unit, historical location data characterizing prior geographic locations of the client device during a first temporal interval, and additionally or alternatively, historical transaction data characterizing one or more prior exchanges of data (e.g., “first” data exchanges) initiated by or involving the client device during the first temporal interval. For example, the information characterizing the first data exchanges may include, but is not limited to, a geographic location associated with each of the first data exchanges, a time or date associated with each of the first data exchanges, or a value of one or more additional parameters that characterize the first data exchanges.

Further, based on the current geographic location of the client device, and on portions of the historical location and transaction data, the computing system may also compute an expected value of a parameter characterizing a second data exchange initiated during a second temporal interval (e.g., an “expected” parameter value that characterizes a “predicted” occurrence of the second data exchange). In some instances, the computing system may determine the expected parameter value based on an application of one or more machine learning algorithms or processes to input data that includes, but is not limited to, the current geographic location of the client device and portions of the historical location and/or transaction data. Examples of the one or more machine learning algorithms or processes include, but are not limited to, an association-rule algorithm (such as an Apriori algorithm, an Eclat algorithm, or an FP-growth algorithm), a clustering algorithm (such as a hierarchical clustering module, a k-means algorithm, or other statistical clustering algorithms), a collaborative filtering algorithm (such as a memory- or model-based algorithm), or an artificial intelligence algorithm (such as an artificial neural network).

The computing system may perform further operations that identify a data type available for use in the second data exchange based on the expected parameter value. For example, the computing system may identify the available data type based on an application of one or more rules or preferences to the expected parameter value, and the computing system may load, from the storage unit, information characterizing the identified data type and a unique identifier of one or more additional computing systems (such as a tokenization system) configured to generate tokenized data representative of the identified data type, e.g., in accordance with one or more data-exchange protocols.

The computing system may generate an additional signal that includes information instructing the tokenization system to generate and provide a tokenized representation of the identified data type, such as a digital token, to the client device prior to the predicted future occurrence of the second data exchange. Upon receipt of the additional signal, the tokenization system may generate the tokenized representation of the identified data type, e.g., the digital token, and provide the tokenized representation to the client device, e.g., through a corresponding programmatic interface. As described herein, the client device may perform operations that initiate the second data exchange by providing the tokenized representation of the identified data type, e.g., the digital token, to a terminal device or to an additional computing system that executes one or more application programs establishing a digital or virtual terminal.

In some examples, the network-connected terminal device and/or the additional computing system may be associated with a merchant, the first data exchanges may correspond to authorized transactions initiated during the first temporal interval, and the second data exchange may facilitate an authorization of a transaction initiated during the second temporal interval. Further, as described herein, one or more of the initiated or authorized transactions may correspond to a transaction in which a customer (e.g., that operates the network-connected device) purchases a product or service from the merchant at an agreed-upon price (e.g., a transaction value). Further, the data type available for use in the second data exchange may correspond to a payment instrument held by the customer and provisioned to an application program executed by the network-connected device (e.g., a payment application that establishes and maintains a mobile wallet).

### I. Exemplary Computing Environments

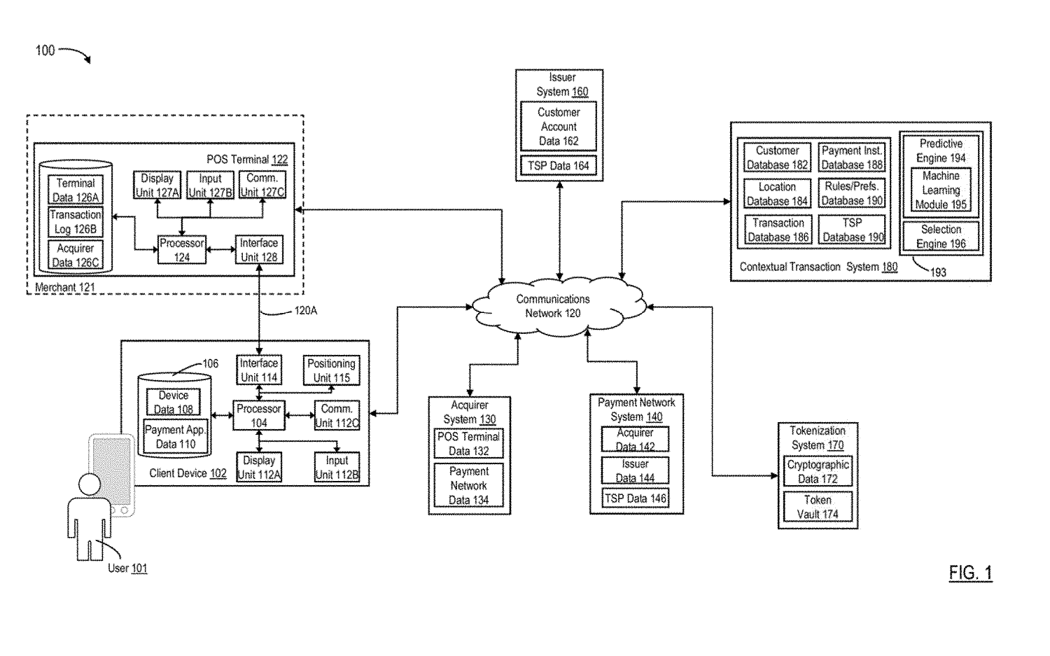

FIG. 1 is a diagram illustrating an exemplary computing environment 100, consistent with certain disclosed embodiments. As illustrated in FIG. 1, environment 100 may include a client device 102, a point-of-sale (POS) terminal 122, an acquirer system 130, a payment network system 140, an issuer system 160, a tokenization system 170, and a contextual transaction system 180, each of which may be interconnected to through any appropriate combination of communications networks, such as communications network 120. Examples of network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

As illustrated in FIG. 1, client device 102 and POS terminal 122 may also exchange data across a direct channel of communications, e.g., direct communication channel 120A. In one aspect, direct communications channel 120A may correspond to a wireless communications channel established across a short-range communications network, examples of which include, but are not limited to, a wireless LAN, e.g., a “Wi-Fi” network, a network utilizing RF communication protocols, a NFC network, a network utilizing optical communication protocols, e.g., infrared (IR) communications protocols, and any additional or alternate communications network, such as those described above, that facilitate peer-to-peer (P2P) communication between POS terminal 122 and client device 102.

POS terminal 122 may, in some instances, be associated with a merchant, e.g., merchant 121, and client device 102 may be associated with or operated by a customer of merchant 121, e.g., user 101. For example, POS terminal 122 may be disposed within a physical location of merchant 121, such as a location where a customer, e.g., user 101, provides payment for goods and/or services (e.g., at a cash register at merchant 121). In one aspect, client device 102 may correspond to a consumer payment device that, upon establishing communication with POS terminal 122 across communications channel 120A, provides data to POS terminal 122 specifying a payment instrument available for use in an initiated transaction for the goods and/or services.

The payment instrument may, in some instances, be issued to user 101 by a financial institution, e.g., a financial institution that operates issuer system 160 (and/or contextual transaction system 180), and issuer system 160 may perform operations that provide the executable payment application to client device 102 for storage within the one or more tangible, non-transitory memories. Payment instruments consistent with the disclosed embodiments include, but are not limited to, a credit, credit card, or reward card accounts held by user 101, an account that includes units of one or more digital or virtual currencies held by user 101, a checking or savings account held by user 101 at one or more financial institutions, an electronic funds transfer, and/or other accounts held by or available to user 101 and capable of funding transaction initiated at POS terminal devices operating within environment 100, such as POS terminal 122.

In some embodiments, client device 102 may include a computing device having one or more tangible, non-transitory memories that store data and/or software instructions, and one or more processors, e.g., processor 104, configured to execute the software instructions. The one or more tangible, non-transitory memories may, in some aspects, store software applications, application modules, and other elements of code executable by the one or more processors, such as a web browser, an application associated with contextual transaction system 180 (e.g., a mobile application), and additionally or alternatively, a payment application associated with a payment service (e.g., a mobile application that establishes and maintains a mobile wallet), as described below.

Client device 102 may also establish and maintain, within the one or more tangible, non-tangible memories, one or more structured or unstructured data repositories or databases, e.g., data repository 106, that include device data 108 and payment application data 110. In one instance, device data 108 may include data that uniquely identifies client device 102, such as a media access control (MAC) address of client device 102 or an IP address assigned to client device 102.

Further, in additional instances, payment application data 110 may include one or more identifiers of the payment application (e.g., a wallet address assigned to the mobile wallet established and maintained by the executed payment application), data identifying one or more payment instruments available to the executed payment application (e.g., tokenized data or cryptograms representative of the payment instruments provisioned to the established mobile wallet), and additional data supporting an operation of the executed payment application (e.g., a mobile wallet cryptogram provided to POS terminal 122 to validate the established mobile wallet, etc.). The disclosed embodiments are, however, not limited to these examples of device and payment application data, and in further aspects, data repository 106 may include any additional or alternate data appropriate to client device 102 and the executed payment application.

Referring back to FIG. 1, client device 102 may also include a display unit 112A configured to present interface elements to user 101, and an input unit 112B configured to receive input from user 101, e.g., in response to the interface elements presented through display unit 112A. By way of example, display unit 112A may include, but is not limited to, an LCD display unit, LED display unit, OLED display unit, or other appropriate type of display unit, and input unit 112B may include, but input not limited to, a keypad, keyboard, touchscreen, voice activated control technologies, or appropriate type of input unit. Further, in additional aspects (not depicted in FIG. 1), the functionalities of display unit 112A and input unit 112B may be combined into a single device, e.g., a pressure-sensitive touchscreen display unit that presents interface elements and receives input from user 101. Client device 102 may also include a communications unit 112C, such as a wireless transceiver device, coupled to processor 104 and configured by processor 104 to establish and maintain communications with network 120 using any of the communications protocols described herein.

Further, in some aspects, client device 102 may include an interface unit 114, which can be configured by processor 104 to establish and maintain communications with POS terminal 122 (e.g., through interface unit 128 of FIG. 1) across communications channel 120A. For example, each of interface unit 114 and interface unit 128 may include a communications device, e.g., a wireless transceiver device, capable of exchanging data across communications channel 120A using any of the short-range communications protocols described above (e.g., NFC protocols, RF communications protocols, Bluetooth™ communication protocols, optical communications protocols, etc.). In other examples, interface unit 114 may include one or more electrical connectors capable of engaging with corresponding electrical connectors of interface unit 128 of POS terminal 122, or an electrical connector capable receiving a wired connection with POS terminal 122 (e.g., a USB connector, FireWire connector, etc.).

Additionally, in some aspects, client device 102 may include a positioning unit 115, such as, but not limited to, a Global Positioning System (GPS) unit, an assisted GPS (aGPS) unit, or a sensor consistent with other positioning systems. Positioning unit 115 may be configured by processor 104 to determine a geographic location of client device 102 (e.g., a latitude, longitude, altitude, etc.) at regular temporal intervals, and to store data indicative of the determined geographic location within a portion of corresponding tangible, non-transitory memory (e.g., within a portion of device data 108), along with data identifying the temporal interval (e.g., a time and/or date).

Examples of client device 102 may include, but are not limited to, a personal computer, a laptop computer, a tablet computer, a notebook computer, a hand-held computer, a personal digital assistant, a portable navigation device, a mobile phone, a smart phone, a tablet, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface module, consistent with disclosed embodiments. In some instances, user 101 may operate client device 102 and may do so to cause client device 102 to perform one or more operations consistent with the disclosed embodiments.

POS terminal 122 may correspond to a computing device that includes one or more tangible, non-transitory memories storing data and/or software instructions, and one or more processors, e.g., processor 124, configured to execute the software instructions. The one or more tangible, non-transitory memories may, in some aspects, store software applications, application modules, and other elements of code, which when executed by the one or more processors, cause POS terminal 122 to perform operations consistent with the disclosed embodiments, as described below. Further, in certain aspects, POS terminal 122 may also store and maintain a data repository, e.g., data repository 126, within the one or more tangible, non-transitory memories. Data repository 126 may, for example, include terminal data 126A that uniquely identifies POS terminal 122 within network 120, a transaction log 126B that identifies transactions initiated at POS terminal 122 and authorized using any of the exemplary processes described herein, and/or acquirer data 126C that uniquely identifies a computer system (e.g., a MAC address, an IP address, etc.) of an entity, e.g., an acquirer, that administers POS terminal 122 and other POS terminals operating in environment 100.

As described above, POS terminal 122 may be disposed within a physical location of the merchant, such as a location where a customer, such as user 101, may provide payment for goods and/or services (e.g., at a cash register at the merchant). POS terminal 122 may, in some instances, include a display unit 127A configured to present interface elements to user 101, and an input unit 127B configured to receive input from user 101, e.g., in response to the interface elements presented through display unit 127A. By way of example, display unit 127A may include, but not be limited to, an LCD display unit or other appropriate type of display unit, and input unit 127B may include, but input not be limited to, a keypad, keyboard, touchscreen, voice activated control technologies, or appropriate type of input unit. Further, in additional aspects (not depicted in FIG. 1), the functionalities of display unit 127A and input unit 127B may be combined into a single device, e.g., a pressure-sensitive touchscreen display unit that presents interface elements and receives input from user 101.

POS terminal 122 may also include a communications unit 127C, such as a wireless transceiver device, coupled to processor 124 and configured by processor 124 to establish and maintain communications with network 120 using any of the communications protocols described herein. Further, POS terminal 122 may include an interface unit 128, which may be configured by processor 124 to establish and maintain communications with client device 102 (e.g., through interface unit 114 of FIG. 1) across communications channel 120A. In some aspects, interface unit 128 may include a communications device, such as a wireless transceiver device, capable of exchanging data with client device 102 using any of the short-range communications protocols described above (e.g., NFC protocols, RF communications protocols, Bluetooth™ communication protocols, optical communications protocols, etc.).

Examples of POS terminal 122 may include, but are not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations consistent with disclosed embodiments. Further, although not depicted in FIG. 1, POS terminal 122 may also be coupled to a computing system associated with and maintained by merchant 121 (e.g., a cash register, etc.), which may include one more processors and one of more tangible, non-transitory memories storing one or more software applications, application modules, and other elements of code that, when executed by the one or more processors, cause the merchant computing system to exchange data with POS terminal 122 and perform operations consistent with the disclosed embodiments.

The disclosed embodiments are not limited to such physical POS terminals, and in additional aspects, POS terminal 122 may correspond to one or more application program modules executed by a computer system maintained by merchant 121, one or more computing systems operating within environment 100, one or more client devices operating within environment 100, such as client device 102 (e.g., a digital or virtual POS terminal accessible across network 120). In other embodiments, POS terminal 122 may represent a device communicatively coupled to client device 102 to provide mobile point-of-sale and payment services, such as a Square™ device in communication with client device 102.

Referring back to FIG. 1, acquirer system 130, payment network system 140, issuer system 160, tokenization system 170, and contextual transaction system 180 may each represent a computing system that includes one or more servers (not depicted in FIG. 1) and tangible, non-transitory memory devices storing executable code and application modules. Further, the servers may each include one or more processor-based computing devices, which may be configured to execute portions of the stored code or application modules to perform operations consistent with the disclosed embodiments, including operations consistent with the generation of tokens based on historical and contextual data as described herein. In other instances, and consistent with the disclosed embodiments, one or more of acquirer system 130, payment network system 140, issuer system 160, tokenization system 170, and contextual transaction system 180 may correspond to a distributed system that includes computing components distributed across one or more networks, such as network 120, or other networks, such as those provided or maintained by cloud-service providers.

In some aspects, acquirer system 130 may perform operations that administer one or more POS terminal devices operating within environment 100, such as POS terminal 122. As illustrated in FIG. 1, acquirer system 130 may maintain, within the one or more tangible, non-transitory memories, POS terminal data 132 that identifies one or more of the POS terminal devices administered by acquirer system 130 (e.g., an IP address, MAC address, or other unique device identifier of POS terminal 122), and payment network data 134 that identifies one or more payment networks capable of clearing and settling transaction initiated by POS terminals administered by acquirer system 130 (e.g., an IP address or other identifier of payment network system 140).

Payment network system 140 may perform operations that, in conjunction with issuer system 160, authorize initiated transactions using one or more exemplary authorization processes, and further, clear and settle authorized transactions using one or more exemplary transaction clearance and settlement processes, such as those consistent with EMV payment protocols. In certain aspects, and to facilitate a performance of these exemplary authorization, clearance, and/or settlement processes, payment network system 140 may maintain acquirer data 142, issuer data 144, and tokenization service provider (TSP) data 146 within the one or more tangible, non-transitory memories. Acquirer data 142 may include data that uniquely identifies one or more acquirer computing systems that administer POS terminals operating within environment 100 (e.g., an IP address, MAC address, or other unique device identifier of acquirer system 130 that administers POS terminal 122). Further, in some instances, issuer data 144 may include data that uniquely identifies computer systems maintained by one or more issuers of payment instruments involved in transactions initiated at POS terminal 122 (e.g., an IP address, MAC address, or other unique identifier of issuer system 160).

In additional instances, TSP data 146 may include information that uniquely identifies a network-connected computing system associated with one or more tokenization service providers operating within environment 100. For example, and as described herein, tokenization system 170 may provide tokenization services to payment network system 140 and additionally or alternatively, to issuer system 160, and TSP data 146 may include an IP address, a MAC address, or another unique identifier of tokenization system 170 within a corresponding communications network, such as network 120 or direct communications channel with another entity or system.

In some aspects, tokenization system 170 may, upon execution of stored software instructions, perform operations that provide tokenization services to payment network system 140 and additionally or alternatively, to issuer system 160 and/or contextual transaction system 180. For example, tokenization system 170 may be configured to receive a tokenized request to authorize a transaction initiated at POS terminal 122 by client device 102, e.g., from payment network system 140 or issuer system 160. The tokenized authorization request may include tokenized account data representative a payment instrument involved in the initiated transaction, and tokenization system 170 may perform operations that “detokenize” the tokenized authorization request (e.g., to “redeem” the tokenized account data for corresponding portions of actual account data), and further, to transmit the detokenized authorization request to a computing system maintained by an issuer of the payment instrument, such as issuer system 160, which may perform any of the exemplary processes described herein to authorize the initiated transaction.

In other instances, and as described herein, tokenization system 170 may also be configured to generate one or more digital tokens that facilitates a performance of an exchange of data between network-connected devices operating within environment 100. For example, the data exchange may correspond to a future occurrence of a transaction, e.g., as expected to be initiated at POS terminal 122 by client device 102. Tokenization system 170 may be configured to receive a request to generate a digital token associated with a payment instrument that is held by user 101 (e.g., who operates client device 102), that is available to fund the transaction and further, that is dynamically selected for use in the transaction using any of the exemplary processes described herein. In response to the received request, tokenization system 170 may perform any of the processes described herein to generate the digital token, portions of which represent and mask sensitive account data associated with the selected payment instrument.

As illustrated in FIG. 1, and to facilitate the performance of one or more of these exemplary tokenization processes, tokenization system 170 may maintain, within on or more tangible non-transitory memories, cryptographic data 172 and a token vault 174. Cryptographic data 172 may, in some instances, specify one or more private, public, or symmetric cryptographic keys capable of decrypting one or more authorization requests selectively encrypted by POS terminal 122. Further, in additional instances, token vault 174 may include structured data records that include tokenized data (e.g., a digital token) representative of one or more payment instruments held by user 101 (and users of other client devices and payment devices operating within environment 100) and that associate the tokenized data with account numbers, expiration dates, card verification values, and other sensitive account data that facilitate an authorization, by issuer system 160, of transactions involving the payment instruments.

Issuer system 160 may maintain, within the one or more tangible, non-transitory memories, data that facilitates an authorization of an exchange of data initiated between network-connected devices operating within environment 100. As described herein, the initiated data exchange may correspond to a transaction initiated at POS terminal 122 by client device 102, and the initiated transaction may be funded by a payment instrument held by user 101 (e.g., which operates client device 102) and issued by a financial institution associated with issuer system 160. In some instances, illustrated in FIG. 1, issuer system 160 may maintain customer account data 162 that identifies underlying accounts (e.g., account numbers, expiration dates, card verification values, etc.) associated with each of the payment instruments issued by issuer system 160 and tokenization service provider (TSP) data 164 that identifies one or more network-connected computing systems (e.g., such as, but not limited to, tokenization system 170) configured to perform any of the exemplary token generation and/or redemption processes described herein for the payment instruments issued by issuer system 160. For example, TSP data 164 may include, but is not limited to, data that specifies an IP address, a MAC address, or other unique identifier of tokenization system 170 and/or other tokenization systems operating within environment 100.

In some aspects, contextual transaction system 180 may maintain, within one or more tangible, non-transitory memories, data that facilitates a determination of parameter values characterizing a future occurrence of a transaction involving user 101 or client device 102 (e.g., expected parameter values). For example, the detected triggering event may correspond to a receipt, from client device 102 across network 120, of location data specifying a current geographic location of client device 102, and the one or more determined parameter values may include, but are not limited to, an expected transaction date or time, an expected transaction amount, an identifier of a merchant involved in expected future occurrence of the transaction (e.g., a merchant name or address, an IP address of POS terminal 122 operated by merchant 121, a merchant category code (MCC) assigned to merchant 121, etc.), or a unique identifier assigned to a product or service involved in the future occurrence of the transaction (e.g., a universal product code (UPC), etc.). Contextual transaction system 180 may determine the expected parameter values based on an application of one or more predictive or analytical processes, such as a machine learning algorithm, to the current geographic location of client device 102, to data characterizing one or more prior geographic locations of client device 102, and additionally or alternatively, to transaction data characterizing one or more prior transactions initiated by client device 102 at corresponding network-connected terminal devices operating within environment 100, such as POS terminal 122, or other digital or virtual terminals accessible across network 120.

In further examples, contextual transaction system 180 may also maintain data within the one or more tangible, non-transitory memories that facilitates a dynamic selection of a payment instrument available to fund the future occurrence of the transaction in accordance with the expected parameter values. As described herein, the dynamic selection of the payment instrument may be based on, among other things, an application of one or more parameter-specific rules or preferences to the expected parameter values and to data characterizing one or more candidate payment instruments available to fund the future occurrence of the transaction (e.g., candidate data types). For example, each of the candidate payment instruments may be held by an operator of client device 102, e.g., user 101, and one or more of the candidate payment instruments may be issued by the financial institution that maintains issuer system 160.

Contextual transaction system 180 may perform additional operations that select a tokenization system capable of providing tokenization services to the selected payment instrument, such as tokenization system 170, and to generate and transmit data identifying the selected payment instrument and the expected parameter values across network 120 to the selected tokenization system. As described herein, the generated and transmitted data may, in certain instances, instruct the selected tokenization system (e.g., tokenization system 170) to generate tokenized data, such as a digital token, that facilitates an initiation of the future occurrence of the transaction in accordance with the expected parameter values, and to provision the generated token data to client device 102 without intervention from client device 102 or user 101, and prior to the future occurrence of the transaction.

Referring back to FIG. 1, contextual transaction system 180 may establish and maintain, within the one or more tangible, non-transitory memories, a customer database 182, a location database 184, transaction database 186, payment instrument database 188, rules and preference database 190, and TSP database 192. In some instances, customer database 182 may include structured or unstructured data records identifying and characterizing one or more customers, such as user 101, that participate in the exemplary dynamic token generation and provisioning processes described herein (e.g., and represent “participating” customers). By way of example, and for user 101, the structured or unstructured data records of customer database 182 may include a unique customer identifier of user 101 (e.g., an authentication credential assigned to user 101 by contextual transaction system 180) and device data that specifies a unique device identifier of a device operated by user 101 (e.g., an IP address, MAC address, or other unique identifier of client device 102).

In some aspects, contextual transaction system 180 may receive data specifying the unique customer identifier and/or the unique device identifier from client device 102 through an initial registration process during which user 101 elects or “opts-in” to participate in the exemplary dynamic token generation and provisioning processes described herein (e.g., based on input provided to client device 102 in response to a presented web page or other digital portal associated with contextual transaction system 180). Further, in some instances, the structured or unstructured data records of customer database 182 may maintain a similar customer identifier for each additional or alternate participating customer, along with a corresponding unique device identifier of a device operated by each of the additional or alternate participating customers.

Location database 184 may include structured or unstructured data records that specify, for each of the network-connected devices operated by the participating customers, a current geographic location of the network-connected device (e.g., during a current temporal interval) and one or more prior geographic locations of the network-connected device during prior temporal intervals. The current or prior geographic location of the each of the network-connected devices may include, but is not limited to, a corresponding latitude, longitude, or altitude. Further, and as described herein, one or more of the network-connected devices, such as client device 102, may execute an application program (e.g., a payment application or a mobile application associated with contextual transaction system 180), and the executed application program may cause each of the network-connected devices to generate and transmit location data specifying its current geographic location (e.g., as captured by an embedded positioning unit, such as positioning unit 115 of client device 102) and a time or date associated with the current geographic location across network 120 to contextual transaction system 180 at predetermined intervals, in response to certain detected events, or in request to response data received from contextual transaction system 180.

Examples of the detected events include, but are not limited to, a disposition of a corresponding one of the network-connected devices in a predetermined geographic region (e.g., within a predetermined geofence, a zip code, etc.), a determination that the corresponding network-connected device crosses a predetermined geographic boundary, a predetermined change in a condition of a communication network (e.g., a loss or resumption of wireless signal), the execution of the application program by the corresponding network-connected device, or a predetermined change in an operational mode of the corresponding network-connected device (e.g., a terminal of a sleep mode, an initiation of a charging operation, etc.). As described herein, contextual transaction system 180 may receive the location data from each of the network-connected devices, and may perform operations that associate each element of received location data with a corresponding unique device identifier (e.g., an IP address or a MAC address of client device 102), and that store the associated location data and unique device identifier within a portion of location database 184. In some aspects, location database 184 may establish a temporal evolution in the geographic location of a network-connected device operated by each of the participating customers (e.g., client device 102 operated by user 101), which contextual transaction system 180 may process using any of the exemplary predictive processes to determine parameter values characterizing an expected future occurrence of a transaction initiated by the network-connected device.

Transaction database 186 may include structured or unstructured data records identifying and characterizing prior transactions initiated at one or more terminal devices (or digital or virtual terminals) operating within environment 100, such as POS terminal 122, by one or more network-connected devices operating within environment 100, such as client device 102 operated by user 101. By way of example, and for each of the prior transactions, the corresponding data record within transaction database 186 may include, but is not limited to, a unique transaction identifier, data identifying and characterizing a party that initiated the transaction, data identifying and characterizing a counterparty to the initiated transaction, data identifying a payment instrument selected to fund the corresponding initiated transaction (e.g., a portion of tokenized payment data, etc.), and values of parameters that characterize the corresponding initiated transaction, such as a transaction amount, a transaction date or time, a currency in which the initiated transaction is denominated, and/or an identifier of a good or service involved in the corresponding transaction (e.g., an assigned universal product code (UPC)).

In some instances, the data identifying and characterizing the initiating party may include, but is not limited to, a unique device identifier of client device 102 (e.g., an IP address, etc.), a cryptogram that uniquely identifies client device 102 or the executed application program (e.g., a mobile wallet cryptogram maintained by the executed application program), or a unique identifier of user 101, and the data identifying and characterizing the counterparty may include, but is not limited to, an IP address or geographic location of POS terminal 122 (or other digital or virtual terminal), an appropriate EMV cryptogram that uniquely identifies POS terminal 122 (e.g., an appropriate cryptogram), or an identifier of merchant 121 (e.g., an assigned MCC, a merchant name or address, etc.). Further, contextual transaction system 180 may receive data characterizing the initiated transactions from POS terminal 122, from payment network system 140, and/or from issuer system 160 through one or more programmatic interfaces (e.g., an application programming interface (API)) at regular or predetermined intervals, or in response to detected occurrences of certain events.

Payment instrument database 188 may include structured or unstructured data records identifying and characterizing one or more payment instruments held by each of the participating customers, such as user 101 that operates client device 102. By way of example, payment instrument database 188 may include a data record associated with each payment instrument held by user 101, and each of the discrete data records may include an identifier of the corresponding payment instrument (e.g., a unique alpha-numeric identifier recognized by payment network system 140, issuer system 160, or tokenization system 170) or an element of account data associated with the corresponding payment instrument (e.g., tokenized payment data that masks sensitive elements of actual account data, etc.), along with additional information (e.g., metadata) that identifies characteristics associated with the corresponding payment instrument. Further, in some examples, each of the data records associated with a corresponding one or more participating customers, such as user 101, may be further associated in payment instrument database 188 with data that uniquely identifies the participating customer (e.g., the authentication credential of user 101) and the client device or devices operated by the participating customer (e.g., the unique device identifier of client device 102).

Examples of these characteristics may include, but are not limited to, an interest rate assess to purchases involving the corresponding payment instrument, a payment grace period associated with the corresponding payment instrument, an available amount of credit or a maximum credit line for the corresponding payment instrument, a currency that denominates the underlying account associated with the corresponding payment instrument, or foreign transaction fees imposed by the payment instrument on foreign transactions. In further examples, the additional data may also information that characterizes a loyalty or rewards program maintained by and associated with the corresponding payment instrument, such as, but not limited to, identifiers of participating merchants, loyalty- or bonus-point allocation schemes (e.g., earning 1.25 bonus points for each $1.00 purchase at Target), and available rewards exchangeable for accrued points (e.g., a $50.00 Visa™ prepaid card in exchange for 3,000 accrued loyalty points). Additionally, in some examples, contextual transaction system 180 may populate the data records of payment instrument database 188 with data received from issuer system 160, or from one or more client devices operating within environment 100, through a corresponding programmatic interface, such an API, at predetermined intervals or in response to certain events.

Rules and preference database 190 includes structured or unstructured data records identifying and characterizing one or more rules or preferences that, in some aspects, facilitate a dynamic selection of a payment instrument available to fund the future occurrence of the transaction. In some instances, at least one of the rules or preferences may be associated with a corresponding one of the participating customers, e.g., user 101, and the data records that identify and characterize at least one rule or preference may include data that uniquely identifiers the corresponding participating customer (e.g., the authentication credential of user 101) or the client device operated by that corresponding participating customer (e.g., an IP or MAC address of client device 102). In further instances, contextual transaction system 180 may establish the at least one rule or preference based on input data received from the client device operated by the corresponding participating customer (e.g., based on input provided by user 101 to client device 102 in response to a presented web page or other digital portal associated with contextual transaction system 180). In other instances, and consistent with certain exemplary embodiments, contextual transaction system 180 may perform operations that generate one or more of the rules or preferences in accordance with, among other things, one or more regulatory protocols or information provided by issuer system 160.

In certain aspects, as described herein, one or more of the rules or preferences may associate a particular payment instrument, or a payment instrument associated with a particular characteristic, with at least one of the expected parameter values. For example, the data records of rules and preference database 190 may specify that a particular payment instrument held by user 101 (e.g., an American Express' credit card) fund any transaction involving one or more particular goods or services, such as purchases of fuel from any merchant or purchases of airline tickets from an airline that maintains a loyalty program via particular payment instrument (e.g., purchases of tickets on Delta™ Airlines, which maintains a loyalty program with American Express™).

Further, and as described herein, user 101 may hold a plurality of payment instruments associated with corresponding characteristics, such as, but not limited to, a corresponding assessed interest rate (e.g., an annual percentage rate (APR)), a corresponding payment grace period, or a corresponding denominating currency (e.g., as specified by the data records of payment instrument database 188). In some instances, the data records of rules and preference database 190 may specify a selection of a corresponding one of the payment instruments associated with a particular characteristic when the expected parameter values satisfy, or fail to satisfy, one or more threshold limitations on parameter value. For example, when an expected transaction amount exceeds a predetermined threshold amount, the data records of rules and preference database 190 may specify the selection of a corresponding one of the payment instruments associated with a minimum assessed interest rate. Alternatively, and when the expected transaction fails to exceed the predetermined threshold amount, the data records of rules and preference database 190 may further specify the selection of a corresponding one of the payment instruments associated with a maximum payment grace period. In other examples, and based on the expected parameter values, contextual transaction system may predict a denomination of the expected future occurrence of the transaction in a foreign currency (e.g., Japanese Yen, Brazilian Reals, Euros, etc.), and the data records of rules and preference database 190 may specify the selection of a correspond one of the payment instruments associated with an underlying account denominated in that foreign currency.

In additional aspects, the data records of rules and preference database 190 may specify a selection of a corresponding one of the payment instruments associated with a loyalty or rewards program maintained by a merchant involved in the expected future occurrence of the transaction. For example, the expected parameter values may indicate that expected future occurrence of the transaction corresponds to a multi-night stay at a Marriot™ hotel, and the data records of rules and preference database 190 may specify the selection of a corresponding payment instrument that provides enhanced loyalty or rewards points (e.g., a “bonus”) for any transaction initiated at a Marriot™ hotel. The disclosed embodiments are, however, not limited to these examples of customer- or system-specified rules or preferences, and in other aspects, the data records of rules and preference database 190 may identify and characterize any additional or alternate selection rule or preference appropriate to the payment instruments held by user 101 and other customers participating in the exemplary dynamic token generation and provisioning processes described herein.

Referring back to FIG. 1, TSP database 192 may include structured or unstructured data records identifying and characterizing one or more tokenization systems that are communicatively coupled to contextual transaction system 180, e.g., across network 120, and configured to perform any of the exemplary token generation or redemption processes described herein. In some aspects, each of the one or more tokenization systems, such as tokenization system 170, may be associated with one or more of the payment instruments held by user 101 and other participating customers (e.g., as specified within payment instrument data 188), and the data records of TSP database 192 may include, for each of the tokenization systems, a unique identifier (e.g., an IP address, a MAC address, or another unique identifier of tokenization system 170) along within additional data identifying the associated payment instrument or instruments. Additionally, in some examples, contextual transaction system 180 may populate the data records of TSP database 192 with information received from the one or more tokenization systems operating within environment 100, such as tokenization system 170, from payment network system 140, or from issuer system 160 through a corresponding programmatic interface (e.g., an application programming interface (API)) at predetermined intervals or in response to certain events.

In further aspects, contextual transaction system 180 may also maintain, within the one or more tangible, non-transitory memories, one or more application programs 193 that facilitate the determination of the parameter values characterizing the future occurrence of the transaction (e.g., the expected parameter values), the selection of an available payment instrument capable of funding the transaction in accordance with the expected parameter values, and the dynamic generation and provisioning of tokenized payment data, such as a digital token, to a network-connected client device prior to the expected future occurrence of the transaction. As illustrated in FIG. 1, application programs 193 may include a prediction engine 194 that, when executed by one or more processors of contextual transaction system 180, cause contextual transaction system 180 to predict the future occurrence of the transaction and determine the expected parameter values characterizing that transaction. As described herein, predictive engine 194 may predict the future occurrence of the transaction and determine the expected parameter values based on input data that include, but is not limited to, historical location data specifying a current and time-evolution of a geographic location of client device 102 (e.g., as maintained within location database 184) and historical transaction data specifying and characterizing one or more prior transactions involving user 101 or initiated by client device 102 (e.g., as maintained within transaction database 186).

In one example, a machine learning module 195 of predictive engine 194 may adaptively and dynamically predict the future occurrence of the transaction and determine the expected parameter values based on an application of one or more machine learning algorithms to portions of the input data described herein, e.g., the portions of location database 184 and transaction database 186. Examples of the one or more machine learning algorithms include, but are not limited to, an association-rule algorithm (such as an Apriori algorithm, an Eclat algorithm, or an FP-growth algorithm), a clustering algorithm (such as a hierarchical clustering module, a k-means algorithm, or other statistical clustering algorithms), a collaborative filtering algorithm (such as a memory- or model-based algorithm), or an artificial intelligence algorithm (such as an artificial neural network).

The machine learning algorithms and/or the artificial intelligence algorithms may, in some instances, be trained against, and adaptively improved, using data characterizing prior geographic locations of other customers or devices operating within environment 100 (e.g., as maintained within location database 184), data characterizing transactions initiated by these other customers or devices during prior temporal intervals (e.g., as maintained within transaction database 186), and expected parameter values determined based on the data characterizing the prior geographic locations or initiated transactions. The disclosed embodiments are, however, not limited to these examples of machine learning algorithms, and in other instances, predictive engine 194 may predict the expected future occurrence and determine the expected parameter values using any additional or alternate algorithm appropriate to the input data described herein, such as, but not limited to, a rule- or preference-based algorithm, a statistical algorithm, or other artificial intelligence algorithms (e.g., an artificial algorithm that does not leverage machine or adaptive learning).

Referring back to FIG. 1, application programs 193 may include a selection engine 196 that, when executed by one or more processors of contextual transaction system 180, cause contextual transaction system 180 to select an available payment instrument capable of funding the expected future occurrence of the transaction in accordance with the expected parameter values, e.g., as determined by predictive engine 194. In some examples, described herein, selection engine 196 may apply one or more of the rules or preferences associated with user 101 and/or client device 102 (e.g., as maintained within rules and preference database 190) to portions of the expected parameter values to select a payment instrument that is held by user 101 and available to fund the future occurrence of the transaction in accordance with the expected parameter values. The disclosed embodiments are, however, not limited to these exemplary selection processes, and in other examples, selection engine 196 may select the payment instrument based on any additional or alternate selection algorithm that would be appropriate to the expected future occurrence of the transaction or to the expected parameter values.

Further, and as illustrated in FIG. 1, contextual transaction system 180 may be implemented separate from client device 102, POS terminal 122, acquirer system 130, payment network system 140, and tokenization system 170, and in communication with these devices and/or systems across communications network 120. In other instances, contextual transaction system 180 may be integrated into, or represent a component of, one or more additional computing system operating within environment 100, such as issuer system 160 and/or tokenization system 170. One of ordinary skill in the art will understand that contextual transaction system 180 could be integrated into, or implemented as part of, one or more additional computing systems, including those operating within environment 100 and not illustrated in FIG. 1, without departing from the scope and spirit of the present disclosure.

### II. Exemplary Computer-Implemented Processes for Dynamically Generating and Provisioning Digital Tokens to Network-Connected Devices

In some embodiments, a network-connected computing system, such as contextual transaction system 180 of FIG. 1, may perform operations that, in response to a detected triggering event, determine a value of one or more parameters characterizing a future occurrence of an exchange of data, and select an available data type capable of initiating the future occurrence of the data exchange in accordance with the determined parameter values. Contextual transaction system 180 may perform further operations that, in conjunction with one or more additional network-connected computing systems (e.g., tokenization system 170 of FIG. 1), generate tokenized data facilitating an initiation of the future occurrence of the data exchange in accordance with the determined parameter values, and provision the tokenized data to a network-connected device associated with the triggering event (e.g., client device 102 of FIG. 1) prior to an expected initiation time of the data exchange. As described herein, client device 102 may execute one or more application programs, when executed by one or more processors of client device 102, cause client device 102 to process the provisioned tokenized data and initiate the data exchange in accordance with the determined parameter values, e.g., by transmitting portions of the tokenized data to a network-connected terminal device across a direct channel of communications.

As described herein, the data exchange may correspond to a transaction involving user 101 or client device 102, and the determined parameter values may specify a future temporal interval during which user 101 of client device 102 is expected to initiate the transaction with the network-connected terminal device (e.g., an expected transaction time for the transaction). The determined parameter values may also include, but are not limited to, an expected value of the transaction, data identifying an expected counterparty to the transaction (e.g., a name or merchant 121 or a classification of merchant 121, such as an MCC), data identifying an expected product or service involved in the transaction (e.g., an assigned UPC), and data identifying the network-connected terminal device (e.g., an IP address or MAC address of POS terminal 122). Additionally, in some examples, the selected data type may correspond to a payment instrument held by user 101 and available to initiate the transaction at the expected transaction time and in accordance with the additional or alternate pones of the determined parameter values. The tokenized data may also include a tokenized representation of the selected payment instrument, such as a digital token, that is valid and usable to, among other things, initiate the future occurrence of the transaction at POS terminal 122 or involving merchant 121.

In additional examples, the detected triggering event may correspond to a receipt by contextual transaction system 180 of certain data from a network-connected device operating within environment 100, such as client device 102. For instance, client device 102 may execute an application program, such as a mobile payment application or a mobile application provided by contextual transaction system 180, which may cause client device 102 to generate and transmit data specifying a current geographic location of client device 102 (e.g., location data) across network 120 to contextual transaction system 180 through a secure programmatic interface. Upon receipt of the location data, contextual transaction system 180 may perform any of the exemplary processes described herein to determine the parameter values that characterize the future occurrence of the transaction, to select dynamically a payment instrument in accordance with one or more rules or preferences associated with user 101 or client device 102, and further, to provision tokenized data facilitating the initiation of the transaction using the selected payment instrument to client device 102. In some aspects, described herein, contextual transaction system 180 may, in conjunction with other computing systems operating within environment 100 (e.g., tokenization system 170), perform operations that provision the tokenized data to client device 102 prior to the future occurrence of the transaction and without intervention from user 101 or client device 102.

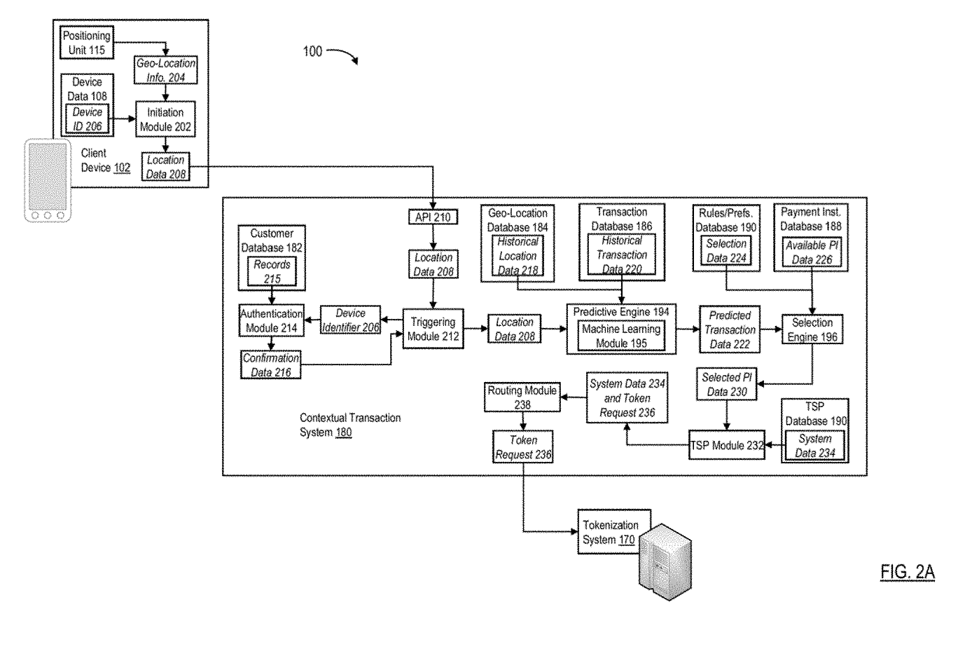

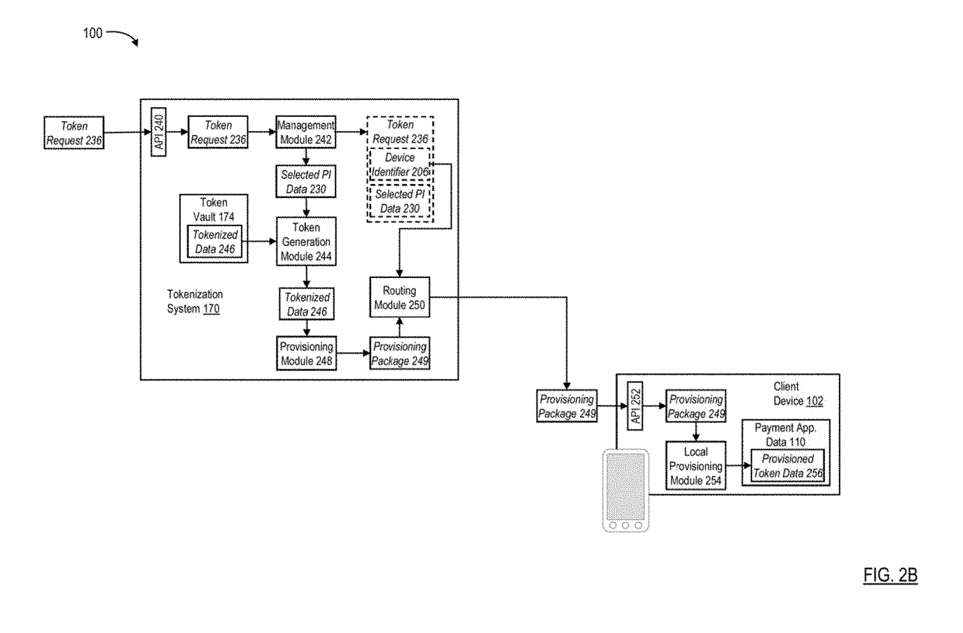

Referring to FIG. 2A, an initiation module 202 of client device 102 may receive information 204 characterizing a current geographic location of client device 102 from positioning unit 115. In some examples, information 204 may specify the current geographic location of client device 102 in terms of a corresponding latitude, longitude, and/or altitude, and may include temporal data specifying at time or date at which positioning unit 115 determined the current geographic location of client device 102. Further, although not illustrated in FIG. 2A, initiation module 202 may perform operations that store portions of information 204 within one or more tangible, non-transitory memories, e.g., within device data 108 of data repository 106.

Initiation module 202 may also access device data 108, and obtain a device identifier 206, such as, but not limited to, an IP address or a MAC address that uniquely identifies client device 102 within environment 100. In some examples, initiation module 202 may package information 204 (e.g., which specifies the current geographic location of client device 102) and device identifier 206 into location data 208, and client device 102 may transmit location data 208 across network 120 to contextual transaction system 180 using any appropriate communications protocol. In one example, initiation module 202 may generate location data 208, and client device 102 may transmit location data 208 to contextual transaction system 180, at predetermined intervals or in response to occurrences of certain events, such as a change in an operation mode of client device 102 (e.g., a push operation). In other examples, the initiation and transmission of location data 208 may be responsive to a receipt, by client device 102, of request data transmitted by contextual transaction system 180 (e.g., a pull operation).

A programmatic interface established and maintained by contextual transaction system 180, such as application programming interface (API) 210, may receive location data 208 from client device 102. By way of example, API 210 may be associated with, and established and maintained by a triggering module 212 of contextual transaction system 180, and may facilitate direct, module-to-module communications between initiation module 202 of client device 102 and triggering module 212. API 210 may provide location data 208 as an input to triggering module 212, and triggering module 212 may perform operations that parse location data 208 to identify and extract device identifier 206, which uniquely identifies client device 102 within environment 100. In some examples, triggering module 212 may provide device identifier 206 as an input to an authentication module 214 executed by contextual transaction system 180.

Based on device identifier 206, authentication module 214 may perform operations that confirm user 101 elected participate in the exemplary dynamic token generation and provisioning processes described herein (e.g., the confirm user 101 is a “participating” customer). For example, authentication module 214 may access data records 215 of customer database 182, which identify and characterize one or more participating customers, and may determine whether any of the participating customers are associated with device identifier 206. If authentication module 214 were to determine that device identifier 206 is not associated with any of the participating customers, authentication module 214 may establish that user 101 did not elect to participate in the exemplary dynamic token generation and provisioning processes described herein, and contextual transaction system 180 may discard location data 208 and await additional data transmitted by client devices operating within environment 100 (not illustrated in FIG. 2A).

Alternatively, if authentication module 214 were to determine that one of more of data records 215 includes device identifier 206, authentication module 214 may establish that user 101 elected to participate in the exemplary dynamic token generation and provisioning processes described herein, and that user 101 represents a participating customer. Authentication module 214 may, in some instances, generate confirmation data 216 indicative of the status of user 101 as a participating customer, and provide confirmation data 216 as an additional input to triggering module 212. In one example, and without limitation, confirmation data 216 may include a unique customer identifier of user 101, such as an authentication credential assigned to user 101 by contextual transaction system 180 (e.g., as extracted from customer database 182). In other examples, confirmation data may also (or alternatively) include device identifier 206.

Triggering module 212 may receive confirmation data 216, and responsive to the determination that user 101 is a participating customer, triggering module 212 may perform operations (not illustrated in FIG. 2A) that store location data 208 within one or more tangible, non-transitory memories, e.g., within data records of location database 184 associated with device identifier 206 (and user 101). Triggering module 212 may also provide location data 208 (e.g., alone or in conjunction with the unique customer identifier of user 101 included within confirmation data 216) as an input to predictive engine 194. In some aspects, predictive engine 194 perform any of the exemplary processes described herein to predict a future occurrence of a transaction involving user 101 and/or client device 102, and to determine expected values of parameters that characterize the future occurrence of the transaction, based on input data that includes, but is not limited to, the current geographic location of client device 102 (e.g., as specified within location data 208), historical location data specifying a time-evolution of a geographic location of client device 102 over prior temporal intervals (e.g., as maintained within location database 184), and historical transaction data specifying and characterizing one or more prior transactions involving user 101 or initiated by client device 102 during these prior temporal intervals (e.g., as maintained within transaction database 186). In some instances, the prior temporal intervals may include, but are not limited to, a portion of a prior day (e.g., twelve hours), a prior day, a prior week, a prior month, a prior year, or any additional or alternate temporal interval appropriate to or established by the data maintained within location database 184 or transaction database 186.

By way of example, predictive engine 194 may receive location data 208, and may perform operations that parse location data 208 to identify and extract the current geographic location of client device 102 (e.g., as specified by a latitude, longitude, or an altitude) and device identifier 206, which uniquely identifies client device 102 within environment 100. Predictive engine 194 may further access location database 184 (e.g., as maintained locally within one or more tangible, non-transitory memories), and obtain historical location data 218 that characterizes a time-evolution in the geographic location of client device 102 during one or more prior temporal intervals. For instance, historical location data 218 may include a plurality of data records, each of which specify a prior geographic location of client device 102 (e.g., as determined by positioning unit 115) and a corresponding time or date at which positioning unit 115 determined the prior geographic location.

Predictive engine 194 may also access transaction database 186 (e.g., as maintained locally within the one or more tangible, non-transitory memories), and may obtain historical transaction data 220 that specifies and characterizes one or more prior transactions involving user 101 or initiated by client device 102 during the one or more prior temporal intervals. In some instances, historical transaction data 220 may include a plurality of data records, each of which correspond to one of the prior transactions involving user 101 or initiated by client device 102. For example, the data record associated with a corresponding one of the prior transactions may include, but is not limited to: a unique transaction identifier (e.g., as establish by a hardware or software-based POS terminal), a transaction amount, a transaction date or time, an identifier of a corresponding merchant (e.g., a merchant name), a merchant type or category (e.g., a merchant category code (MCC) assigned to the corresponding merchant), or an identifier of a product or service in the corresponding one of the prior transactions (e.g., an assigned universal product code (UPC)).

In some instances, historical location data 218 and historical transaction data 220 may, in conjunction with the current geographic location of client device 102, represent input data to predictive engine 194, which may predict the future occurrence of the transaction and determine the expected parameter values based on an application of any of the predictive processes described herein to portions of the input data. By way of example, and based on an application of apply any of the machine learning algorithms or processes described herein to portions of historical location data 218 and historical transaction data 220, machine learning module 195 of predictive engine 194 may establish patterns among, or correlations between, the prior geographic locations of client device 102 and the prior transactions. Machine learning module 195 may further predict the future occurrence of the transaction that would be consistent with the established parameters or correlations and the current geographic location of the client device, and determine the expected parameter values that characterize the predicted future occurrence. The disclosed embodiments are, however, not limited to the exemplary machine learning algorithms or processes described herein, and in other instances, predictive engine 194 may predict the expected future occurrence and determine the expected parameter values using any additional or alternate analytical or statistical algorithm that would be appropriate to the input data.

For example, location data 208 may indicate that client device 102 (and thus, user 101) is currently positioned in Washington, D.C., at the corner of 22^{nd} and I Streets NW (e.g., 38° 54′ N latitude, and 77° 02′ W longitude) at 8:35 a.m. on Wednesday, Dec. 20, 2017. In some instances, predictive engine 194 may perform any of the exemplary processes described herein (e.g., such as, but not limited to, the application of one or more machine learning algorithms or processes by machine learning module 195) to predict that user 101 will next initiate a transaction at a Devon & Blakely™ market located at 2200 Pennsylvania Avenue NW at 8:45 a.m. on December 20^{th}. Further, and based on the performance of any of the exemplary processes described herein, predictive engine 194 may also determine that predicted transaction at the Devon & Blakely™ market will correspond to a purchase of a large oatmeal and a large coffee by user 101 in the amount of $7.85.

Referring back to FIG. 2A, predictive engine 194 may generate predicted transaction data 222 that includes the unique device identifier of client device 102, e.g., device identifier 206, along with data that identifies the predicted future occurrence of the transaction and the expected parameter values that characterize the future occurrence. Examples of the expected parameter values include, but are not limited to, an expected transaction date or time (e.g., 8:45 a.m. on Dec. 20, 2017), an expected transaction value (e.g., $7.85), a merchant name (e.g., the Devon & Blakely™ market), the merchant location (e.g., 2200 Pennsylvania Avenue NW), a merchant type (e.g., an MCC characterizing the Devon & Blakely™ market, such as a “specialty markets” code), and an identifier of a corresponding good or service (e.g., a UPC code assigned to the large oatmeal and/or the large coffee). In some examples, predictive engine 194 may provide predicted transaction data 222 as an input to selection engine 196, which may perform any of the exemplary processes described herein to select a payment instrument that is held by user 101 and available to fund the predicted future occurrence of the transaction in accordance with one or more rules or preferences associated with user 101, client device 102, and/or contextual transaction system 180 (e.g., as maintained within rules and preference database 190).

Selection engine 196 may receive predicted transaction data 222, and in some examples, may perform operations that parse predicted transaction data 222 to extract device identifier 206, which uniquely identifies client device 102 within environment 100, and data specifying the expected parameter values that characterize the predicted future occurrence of the transaction (e.g., the $7.85 purchase of oatmeal and coffee from the Devon & Blakely™ market at 8:45 a.m. on Dec. 20, 2017). Selection engine 196 may access rules and preference database 190 (e.g., as maintained locally within one or more tangible, non-transitory memories), and obtain selection data 224 that specifies and characterizes one or more rules or preferences associated with user 101, client device 102, and/or contextual transaction system 180. For example, selection data 224 may include a plurality of data records, each of which are associated with device identifier 206 and include additional information, such as metadata, identifying a corresponding one of the rules or preferences applicable to the selection of a payment instrument appropriate to the expected parameter values that characterize the predicted future occurrence of the transaction.

For example, selection data 224 may identify a preference that a particular payment instrument, such an American Express' credit card held by user 101, fund any transaction involving one or more particular goods or services, such as purchases of airline tickets from Delta™ Airlines, which maintains a loyalty program with American Express™. In other examples, selection data 224 may identify a rule indicating that, when an expected transaction value exceeds a threshold amount specified by user 101 (e.g., $500.00 threshold), selection engine 196 should select an available payment instrument that is characterized by a minimum assessed interest rate. Further, selection data 224 may include one or more preferences that, when the expected transaction value is denominated in a foreign currency, selection engine 196 should select an available payment instrument associated with an underlying account denominated in that foreign currency. In other examples, selection data 224 may include a “default” preference (e.g., as established by user 101) indicating a particular payment instrument held by user 101, such as a Visa™ credit card, fund any transaction characterized by an expected transaction value that falls below an additional threshold amount, such as $20.00. The disclosed embodiments are, however, not limited to these examples of customer- or system-specified rules or preferences, and in other aspects, selection data 224 may identify and characterize any additional or alternate selection rule or preference appropriate to the payment instruments held by user 101, the issuers of these payment instruments, or contextual transaction system 180.

Referring back to FIG. 2A, selection engine 196 may also access payment instrument database 188 (e.g., as maintained locally within the one or more tangible, non-transitory memories), and obtain available payment instrument (PI) data 226 that identifies and characterizes one or more payment instruments held by user 101 and available to fund the predicted future occurrence of the transaction (e.g., the $7.85 purchase of oatmeal and coffee from the Devon & Blakely™ market at 8:45 a.m. on Dec. 20, 2017). In some examples, available payment instrument (PI) data 226 may include one or more data records, each of which associate device identifier 206 with an identifier of a corresponding payment instrument (e.g., a unique alpha-numeric identifier recognized by payment network system 140, issuer system 160, or tokenization system 170, such as a bank identification number (BIN) or an issuer identifier number (T N), or portions of account information) and additional information that identifies characteristics associated with the corresponding payment instrument. As described herein, examples of these characteristics may include, but are not limited to, an interest rate applied to purchases involving the corresponding payment instrument, a payment grace period associated with the corresponding payment instrument, a maximum credit line for the corresponding payment instrument, a loyalty or rewards program associated with the corresponding payment instrument, or a currency that denominates the underlying account associated with the corresponding payment instrument.

By way of example, and without limitation, user 101 may hold payment instruments that include: (i) an American Express™ credit card associated with a loyalty program that awards double points for purchases of airline tickets from Delta™; (ii) a MasterCard™ credit card associated with an annual percentage rate of 17.75% and a thirty-day grace period on interest charges on new purchases; and (iii) a Visa™ credit card associated with an annual percentage rate of 4.75%. The American Express™ credit card, the MasterCard™ credit card, and the Visa™ credit card may each be available to fund the predicted future occurrence of the transaction, and available payment instrument (PI) data 226 may include data records that specify the unique identifier of, and the characteristics associated with, corresponding ones of the American Express™ credit card, the MasterCard™ credit card, and the Visa™ credit card.

In some examples, selection engine 196 may perform operations that select one of the available payment instruments (e.g., the available American Express™ credit card, the MasterCard™ credit card, and the Visa™ credit card) to fund the future occurrence of the transaction based on an application of the rules or preferences identified within selection data 224 to portions of available payment instrument (PI) data 226 and to the data identifying the expected parameter values (e.g., as extracted from predicted transaction data 222). For example, selection engine 196 may establish that the expected transaction amount of $7.85 for transaction at the Devon & Blakely™ market falls below the $20.00 threshold value specified in selection data 224 for the Visa™ credit card, and selection engine 196 may select the Visa™ credit card to fund the future occurrence of the transaction at the Devon & Blakely™ market (e.g., at 8:45 a.m. on Dec. 20, 2017). Selection engine 196 may also extract one or more of the data records that identify and characterize the selected payment instrument, e.g., Visa™ credit card, from available payment instrument (PI) data 226, and package the extracted data records and device identifier 206 into selected payment instrument (PI) data 230, which selection engine 196 may provide as an input to a tokenization service provider (TSP) module 232.

TSP module 232 may process selected payment instrument (PI) data 230 to identify the selected payment instrument, e.g., Visa™ credit card, and may access the data records of TSP database 190 to identify a corresponding tokenization system, such as tokenization system 170, configured to generate a tokenized representation of the selected payment instrument, e.g., a digital token for the Visa™ credit card. In one example, TSP module 232 may identify the selected payment instrument (e.g., the Visa™ credit card) based on a value of the unique identifier of the Visa™ credit card within selected payment instrument (PI) data 230, and may determine that a corresponding one of the data records within TSP database 190 includes the unique identifier.

In some examples, TSP module 232 may also extract, from the corresponding one of the data records, system data 234 that identifies the tokenization system, e.g., tokenization system 170, configured to generate the tokenized representation of the selected payment instrument, e.g., the payment token for the selected Visa™ credit card. For example, system data 234 may include a network address, such as an IP address or a MAC address, that uniquely identifies tokenization system 170 within environment 100. TSP module 232 may further package device identifier 206, which uniquely identifies client device 102 within environment 100, and portions of selected payment instrument (PI) data 230 into a token request 236, and TSP module 232 may provide system data 234 and token request 236 as an input to a routing module 238 of contextual transaction system 180. In one example, system data 234 may be incorporated into a portion of token request 236, e.g., a header portion, although in other examples, system data 234 and token request 236 may be separate and distinct elements of data.

Routing module 238 may receive system data 234 and token request 236 (e.g., as a single data element or as separate data elements). Based on portions of system data 234, routing module 238 may perform operations that transmit token request 236 across network 120 to the network address of tokenization system 170 using any of the communication protocols described herein. In some examples, token request 236 may include information that instructs tokenization system 170 to perform any of the exemplary processes described herein to generate the tokenized representation of the selected payment instrument (e.g., the payment token for the Visa™ credit card) in accordance with token request 236, and to automatically provision the tokenized representation (e.g., the generated payment token) to client device 102 in real-time and prior to the predicted future occurrence of the transaction.

Referring to FIG. 2B, a programmatic interface established and maintained by tokenization system 170, such as application programming interface (API) 240, may receive token request 236 from contextual transaction system 180. By way of example, API 240 may be associated with, and established and maintained by a management module 242 of tokenization system 170, and may facilitate direct, module-to-module communications between routing module 238 of contextual transaction system 180 and management module 242. API 240 may provide token request 236 as an input to management module 242, which may store token request 236 (e.g., including device identifier 206 and the portions of selected payment instrument (PI) data 230) within one or more locally or remotely accessible tangible, non-transitory memories. Management module 242 may also parse token request 236 to extract the portions of selected payment instrument (PI) data 230, and provide the extracted portions of selected payment instrument (PI) data 230 as an input to a token generation module 244 of tokenization system 170.

In some examples, token generation module 244 may receive the extracted portions of selected payment instrument (PI) data 230, which includes the unique identifier of the selected payment instrument, e.g., the selected Visa™ credit card. As described herein, the unique identifier of the selected Visa™ credit card may be recognizable by tokenization system 170. Using the unique identifier of the selected Visa™ credit card, token generation module 244 may access token vault 174 (e.g., as maintained within one or more tangible, non-transitory memories), and obtain tokenized data 246 that is representative of, and linked to, the sensitive underlying account information that characterizes the selected Visa™ credit card.

For example, tokenized data 246 may include a digital token that masks all or a portion of the sensitive, underlying account information characterizing the Visa™ credit card, such as, but not limited to, an underlying account number, an expiration date, or a card verification value (CVV). The digital token may be generated by tokenization system 170, either alone or in conjunction with a corresponding system maintained by an issuer of the selected Visa™ credit card, such as issuer system 160, and may be formatted in accordance with one or more payment or authorization protocols, such as an EMV payment protocol. Further, when provisioned to a device operated by user 101, such as client device 102, the digital token may facilitate an initiation of a transaction involving the selected Visa™ credit card at a corresponding POS terminal, such as POS terminal 122 or a virtual terminal generated by application programs executed at a computing system operated by merchant 121. As described herein, acquirer system 130, payment network system 140, issuer system 160, and tokenization system 170 may collectively perform operations that authorize, clear, and settle the transaction involving the digital token in accordance with the underlying payment or authorization protocol, e.g., the EMV payment protocol.

Referring back to FIG. 2B, token generation module 244 may provide tokenized data 246 as an input to a provisioning module 248 of tokenization system 170, which may perform operations that package all or a portion of tokenized data 246 into provisioning package 249. For example, provisioning package 249 may include the digital token representative of the selected Visa™ credit card, e.g., as obtained from token vault 174. In other examples, provisioning package 249 may include one or more elements of additional data that facilitate the provisioning of the digital token to client device 102 (e.g., device identifier 206 or additional information or cryptograms associated with a mobile payment application executed by client device 102) or the initiation of the transaction in accordance with the payment or authorization protocols (e.g., one or more EMV-specific cryptograms, etc.). Provisioning module 254 may provide provisioning package 249 as an input to routing module 250, which may access digital identifier 206 (e.g., which uniquely identifies client device 102 within environment 100) and perform operations that transmit provisioning package 249 across network 120 to client device 102 using any of the communication protocols described herein.

A programmatic interface established and maintained by client device 102, such as application programming interface (API) 252, may receive provisioning package 249 from tokenization system 170. By way of example, API 252 may be associated with, and established and maintained by a local provisioning module 254 of client device 102, and may facilitate direct, module-to-module communications between routing module 250 of tokenization system 170 and local provisioning module 254. API 252 may provide provisioning package 249 as an input to local provisioning module 254, which may perform any of the exemplary processes described herein to automatically provision the digital token, which represents the selected Visa™ credit card, to client device 102 prior to the predicted future occurrence of the transaction automatically and without intervention from user 101.

In some examples, local provisioning module 254 may be associated with, or represent a component of, a mobile payment application that, when executed by client device 102, establishes and maintains a mobile wallet provisioned with one or more payment instruments (e.g., digital tokens) available for use in transactions initiated by client device 102. As illustrated in FIG. 2B, local provisioning module 254 may process provisioning package 249, extract the digital token representative of the selected Visa™ credit card, and store the extracted digital token within a corresponding portion of payment application data 110, e.g., as provisioned token data 256. In further examples (not illustrated in FIG. 2B), local provisioning module 254 may also store additional elements of data that support the initiation of transactions based on provisioned token data 256, such as, but not limited to, cryptograms or protocol-specific data within provisioning package 249 that enable the authorization, clearance, and settlement of initiated transactions in accordance with EMV payment protocols. Upon storage of the provisioned token data 256, and any additional or alternate supporting data, the selected Visa™ credit card may be provisioned for use in transactions initiated by client device 102 at corresponding POS terminals, such as the predicted future occurrence of the $7.85 purchase of oatmeal and coffee from the Devon & Blakely™ market at 8:45 a.m. on Dec. 20, 2017.

For example, at approximately 8:45 a.m. on Dec. 20, 2017, user 101 may enter the Devon & Blakely™ market at 2200 Pennsylvania Avenue, N.W., and may present the oatmeal and coffee at a cash register or other computing system maintained by the Devon & Blakely™ market (e.g., which corresponds to merchant 121 of FIG. 1). The merchant computing system may obtain transaction data characterizing the transaction, such as the $7.85 transaction value and the identifier oatmeal and coffee (e.g., the assigned UPC codes), and provide the obtained transaction data to POS terminal 122 across any appropriate wired or wireless connection. POS terminal 122 may receive the transaction data from the merchant computing system, and may perform operations that generate interface elements representative of portions of the received transaction data, which POS terminal 122 may present within a graphical user interface (GUI) displayed on display unit 127A.

In response to the presented interface elements, which may prompt user 101 to provide a payment instrument capable of funding the transaction amount of the initiated transaction, user 101 may dispose client device 102 proximate to POS terminal 122, and interface unit 114 of client device 102 may establish communications channel 120A with POS terminal 122 (e.g., through the communications device included within interface unit 128 of POS terminal 122 using any of the short-range, wireless communication protocols described above). Processor 104 of client device 102 may execute a payment application (e.g., a mobile wallet application) that causes client device 102 to present, to user 101 through display unit 112A, interface elements that identify one or more payment instruments maintained within a mobile wallet established by the executed payment application and available to fund the initiated transaction.

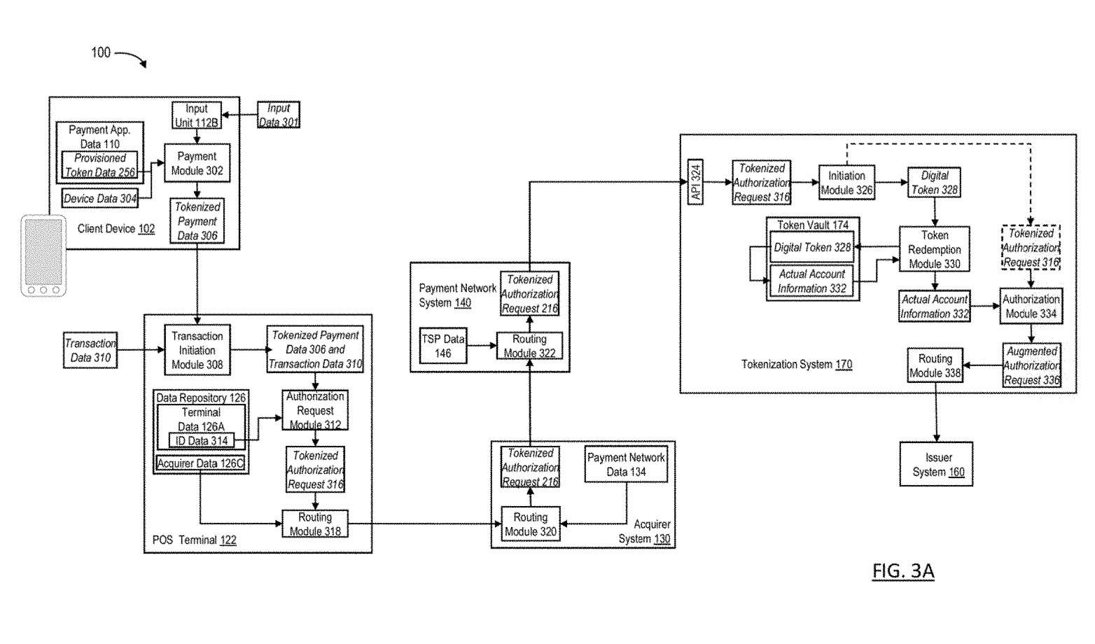

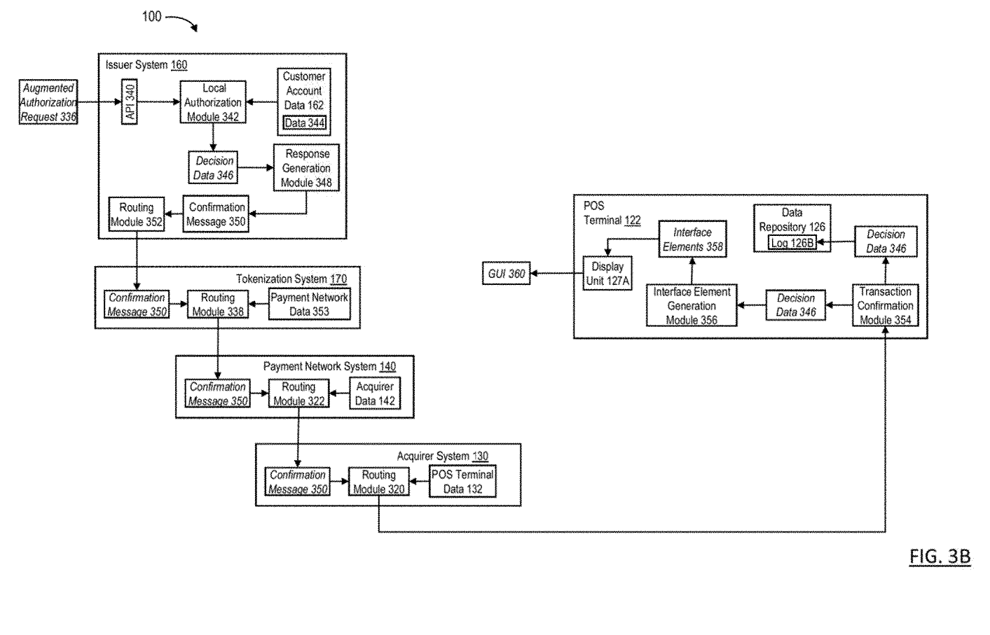

By way of example, user 101 may elect to fund the initiated transaction with the now-provisioned Visa™ credit card and may provide input identifying the Visa™ credit card to client device 102, e.g., by providing input data 301 to input unit 112B. Referring to FIG. 3A, a payment module 302 of client device 102 may receive input data 201 that identifies the Visa™ credit card selected by user 101 to fund the initiated transaction, e.g., the $7.85 purchase of the oatmeal and coffee from the Devon & Blakely™ market. Payment module 302 may process input data 301 to obtain an identifier of the Visa™ credit card, and based on the obtained identifier, perform operations that access and load a portion of payment application data 110 that corresponds to the Visa™ credit card.

For example, payment module 302 may access payment application data 110 (e.g., as maintained within data repository 106), and load provisioned token data 256 associated with the Visa™ credit card. As described herein, provisioned token data 256 may include a digital token that masks all or a portion of the sensitive, underlying account information characterizing the Visa™ credit card, such as, but not limited to, an underlying account number, an expiration date, or a card verification value (CVV). Further, provisioned token data 256 may include additional or alternate information facilitating an initiation, authorization, settlement, and clearance of transaction in accordance with one or more payment or authorization protocols, such as the EMV payment protocol described herein.

Referring back to FIG. 2A, payment module 302 may perform additional operations that access and load, from corresponding portions of data repository 106, device data 304 that uniquely identifies client device 102 within environment 100 (e.g., an IP address, a MAC address, a unique identifier of user 101, etc.). Payment module 302 may package portions of provisioned token data 256 and device data 304 into tokenized payment data 306, which client device 102 may transmit across communications channel 120A to POS terminal 122 using any of the short-range communications protocols outlined above. In some examples, not illustrated in FIG. 2A, tokenized payment data 306 may also include data that identifies and authenticates the mobile wallet established and maintained by payment module 302, such a mobile wallet token, a mobile wallet cryptogram, or a unique mobile wallet address.

A transaction initiation module 308 of POS terminal 122 may receive tokenized payment data 306 from client device 102, and further, may receive transaction data 310 from the merchant computing system, e.g., the cash register operated by merchant 121. Transaction data 310 may, for example, include data characterizing the initiated transaction, such as, but not limited to, the corresponding transaction value (e.g., $7.85), the corresponding transaction time or date (e.g., 8:45 a.m. on Dec. 20, 2017), and the identifier of the product or products involved in the transaction (e.g., the UPCs assigned to the oatmeal and the coffee). In some aspects, transaction initiation module 308 may provide portions of tokenized payment data 306 and transaction data 310 as an input to an authorization request module 312, which may perform any of the exemplary processes described herein to generate an authorization request for the initiated transaction.

For example, authorization request module 312 may receive tokenized payment data 306 and transaction data 310, and may perform additional operations that access and load data identifying POS terminal 122, e.g., terminal identification data 314, from a corresponding portion of data repository 126, e.g., from terminal data 126A. In some instances, terminal identification data 314 may include a unique network address of POS terminal 122 within environment 100, such as an IP address or a MAC address. In other instances, terminal identification data 314 may include a POS cryptogram that uniquely identifies POS terminal 122, which may be generated and assigned to POS terminal 122 by payment network system 140. The POS cryptogram may, for examples, be formatted in accordance with one or more appropriate payment or authorization protocols, such as the EMV payment protocol described herein. Authorization request module 312 may perform operations that package tokenized payment data 306, transaction data 310, and terminal identification data 314 into a tokenized authorization request 316. As described herein, tokenized authorization request 316 may include the digital token associated with the selected Visa™ credit card, which masks sensitive portions of the underlying account information during transmission across network 120.

As illustrated in FIG. 2A, authorization request module 312 may provide tokenized authorization request 316 as an input to a routing module 318 of POS terminal 122. For example, routing module 318 may access and load a network address of acquirer system 130 from acquirer data 126C (e.g., the MAC address or the IP address of acquirer system 130). Further, routing module 318 may perform operations that transmit tokenized authorization request 316 across network 120 to the network address of acquirer system 130, e.g., through communications unit 127C using any of the communications protocols outlined above.

A routing module 320 of acquirer system 130 may receive tokenized authorization request 316 from POS terminal 122. In some examples, routing module 320 may access payment network data 134 and extract a network address of payment network system 140 (e.g., a MAC address or an IP address of a payment network or rail configured to authorize, clear, and settle initiated transactions involving the Visa™ credit card). In certain aspects, routing module 320 may transmit tokenized authorization request 316 across network 120 to the extracted network address of payment network system 140, e.g., using any of the communications protocols described above.

A routing module 322 of payment network system 140 may receive tokenized authorization request 316 from acquirer system 130, which received and relayed tokenized authorization request 316 from POS terminal 122. In some examples, routing module 322 may access TSP data 146, obtain a portion of the stored data identifying a network address of tokenization system 170, which may be configured to redeem the digital token representative of the selected Visa™ credit card, may transmit tokenized authorization request 316 to the network address of the tokenization system 170 through a corresponding API or other programmatic interface.

In some examples, a programmatic interface of tokenization system 170, e.g., application programming interface (API) 324, may receive tokenized authorization request 316 and may provide tokenized authorization request 316 as an input to an initiation module 326. In some aspects, API 324 may be associated with or established by initiation module 326, and may facilitate secure, module-to-module communications across network 120 between routing module 322 of payment network system 140 and initiation module 326. Initiation module 326 may perform operations that store the tokenized authorization request 316 within a portion of a tangible, non-transitory memory, and may process tokenized authorization request 316 to extract digital token 328, which represents and masks sensitive account data associated with the selected Visa™ credit card, and to provide digital token 328 as an input to a token redemption module 330.

Token redemption module 330 may access token vault 174 (e.g., as maintained within a tangible, non-transitory memory by tokenization system 170), and access and load actual account information 332 associated with digital token 328. An authorization module 334 of the tokenization system 170 may receive actual account information 332 from token redemption module 330, and may perform operations that incorporate portions of actual account information 332 into tokenized authorization request 316, e.g., to generate an augmented authorization request 336, and to provide augmented authorization request 336 as an input to routing module 338. As described below in reference to FIG. 3B, routing module 338 may perform operations that transmits the augmented authorization request 336 across network 120 to issuer system 160 using any of the communications protocols described herein.

Referring to FIG. 3B, a programmatic interface of issuer system 160, e.g., an authorization API 340 maintained by a local authorization module 342 of the issuer system 160, may receive augmented authorization request 336, and relay augmented authorization request 336 to local authorization module 342. In some instances, authorization API 340 may facilitate secure, module-to-module communication between routing module 338 and local authorization module 342 across network 120. In some examples, local authorization module 342 may process augmented authorization request 336 to extract transaction data that includes, but is not limited to, the transaction value that characterizes the initiated transaction (e.g., $7.85) and account data that characterizes the Visa™ credit card (e.g., the account number, expiration data, and/or card verification value of the originator payment instrument). Further, local authorization module 342 may also access stored data that characterizes a current account status of one or more payment instruments issued by the financial institution that maintains issuer system 160 (e.g., within customer account data 162), and load one or more data records 344 of customer account data 162 that characterize the current status of the selected Visa™ credit card. Data records 344 may specify, among other things, a current account balance of the Visa™ credit card, a credit limit established for the originator payment instrument, and/or values of other account parameters that characterize the Visa™ credit card.

In some instances, local authorization module 342 may determine whether to authorize the initiated transaction using the Visa™ credit card based on the extracted transaction data and the data characterizing the current status of the Visa™ credit card, and in accordance with the one or more payment or authorization protocols, such as the EMV payment protocol described herein. Local authorization module 342 may generate decision data 346 indicative of the decision to authorize, or alternatively, decline, the initiated transaction using the Visa™ credit card.

For example, an in response to a decision to authorize the initiated transaction using the Visa™ credit card, local authorization module 342 may generate an authorization code, and package the generated authorization code and data that characterizes the authorized transaction (such as the authorized transaction amount, the parties to the authorized transaction, etc.) into decision data 346. In other examples, and in response to a decision to the decline the initiated transaction (e.g., when the transaction amount would increase the account balance of the originator payment instrument above the credit limit, etc.), local authorization module 342 may generate a code or other data indicative of the declined transaction, and incorporate the generated code or other data into decision data 346, along with additional or alternate data characterizing the declined transaction.

In some aspects, local authorization module 342 may provide decision data 346 as an input to a response generation module 348. Response generation module 348 may perform operations that package all or a portion of decision data 346 into a confirmation message 350 indicative of the authorized or declined status of the initiated transaction. Response generation module 348 may further provide confirmation message 350 an as input to a routing module 352, which perform operations that transmits confirmation message 350 across network 120 to tokenization system 170.

Tokenization system 170 may receive confirmation message 350 through a corresponding programmatic interface, such as an API (not illustrated in FIG. 3B), and routing module 338 may access and load a unique device identifier (e.g., an IP address, etc.) of payment network system 140 from a tangible, non-transitory memory (e.g., from payment network data 353). Routing module 338 may perform further operations that transmit confirmation message 350 across network 120 to the device identifier of payment network system 140 using any of the communications protocols described herein.

Routing module 322 of payment network system 140 may receive confirmation message 350 from the tokenization system 170 (e.g., through a corresponding programmatic interface or API), and may transmit confirmation message 350 to acquirer system 130 across network 120. Further, routing module 320 of acquirer system 130 may receive confirmation message 350 from payment network system 140, may transmit confirmation message 350 to POS terminal 122 across network 120. In some examples, not illustrated in FIG. 3B, payment network system 140 may, in conjunction with issuer system 160 and acquirer system 130, perform operations that settle and clear the now-authorized transaction (e.g., by debiting and crediting accounts maintained on behalf of corresponding ones of issuer system 160 (and thus, user 101) and acquirer system 130 (and thus, merchant 121) in accordance with the one or more payment or authorization protocols, such as the EMV payment protocol described herein.

POS terminal 122 may receive confirmation message 350 through communications unit 127C (not depicted in FIG. 3B), and a transaction confirmation module 354 may perform operations that extract decision data 346 from confirmation message 350. In some aspects, decision data 346 may include the authorization code and the additional data that characterizes the authorized transaction (e.g., the authorized transaction amount, the parties to the authorized transaction, etc.), which POS terminal 122 stores within one or more data records of transaction log 126B, along with additional values of transaction parameters, such as, but not limited to, a transaction time and date or a transaction location. In other instances, described herein, decision data 346 may include the generated code and the additional data that characterizes the declined transaction. In some examples, not illustrated in FIG. 3B, POS terminal 122 may perform additional operations that validate and authenticity and an integrity of confirmation message 350 in accordance with the one or more payment or authorization protocols, such as the EMV payment protocol described herein.

Transaction confirmation module 354 may also provide decision data 346 to an interface element generation module 356, which may process decision data 346 to generate one or more interface elements 358. In some aspects, interface element generation module 356 may provide generated interface elements 358 to display unit 127A, which may present interface elements 358 within a graphical user interface (GUI) 360 that identifies the authorization code and confirms the authorization of the initiated transaction. In other instances, interface elements 358 may be representative of the declined transaction, and when rendered for presentation by display unit 127 on GUI 360, interface elements 358 may confirm the declined transaction.

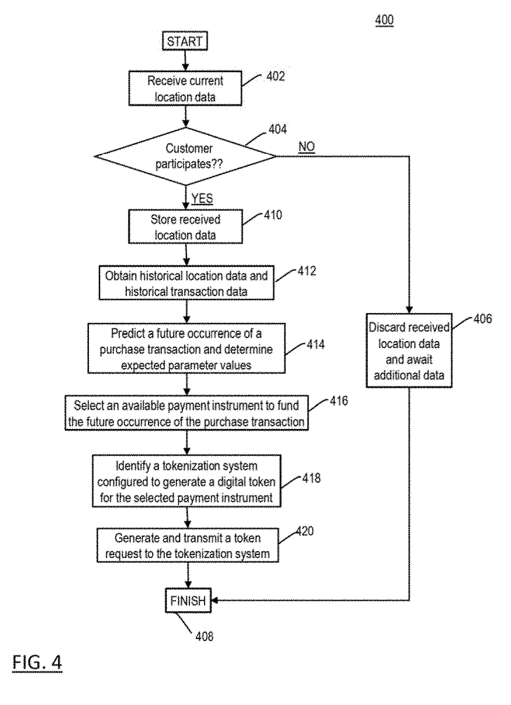

FIG. 4 is a flowchart of an exemplary process 400 for dynamically generating and provisioning tokenized data to network-connected devices, in accordance with the disclosed embodiments. In some examples, contextual transaction system 180 may perform the steps of exemplary process 400, which include predicting a future occurrence of a data exchange initiated by a network-connected device, determining of parameter values expected to characterize the future occurrence of the data exchange based on a current geographic location of the network-connected device, and selecting a data type available to initiate the future occurrence of the data exchange based on one or more rules or preferences. The data exchange may, for example, correspond to a transaction initiated by a customer that operates the network-connected device (e.g., user 101 that operates client device 102 of FIG. 1) at a network-connected terminal device of a merchant (e.g., POS terminal 122 maintained by merchant 121 of FIG. 1) or through a digital terminal established by one or more application programs executed by a network-connected computing system associated with the merchant.

Referring to FIG. 4, contextual transaction system 180 may receive location data characterizing a current geographic location of client device 102 (e.g., in step 402). In some examples, the received location data may include a unique identifier of user 101 (e.g., an authentication credential assigned by contextual transaction system 180) or a unique identifier of client device 102 within environment 100 (e.g., an assigned IP or MAC address), and may specify current geographic location of client device 102 in terms of a latitude, longitude, or altitude. As described herein, contextual transaction system 180 may receive the location data from client device 102 at predetermined intervals or in response to occurrences of certain events (e.g., via a push operation) or in response to request data provided to client device 102 (e.g., a pull operation).

In response to the received location data, contextual transaction system 180 may determine whether user 101 elected to participate in the exemplary token generation and provisioning processes described herein (e.g., in step 404). For example, in step 404 contextual transaction system 180 may access stored customer data that identifies and characterizes one or more participating customers (e.g., as maintained within customer database 182 of FIG. 1), and determine whether the stored customer data includes the unique identifier of user 101 or client device 102. If the stored customer data were not to include the unique identifier of user 101 or client device 102, contextual transaction system 180 may determine that user 101 did not elect to participate in the exemplary token generation and provisioning processes described herein and as such, that user 101 does not represent a “participating customer” (e.g., step 404; NO). In response to this determination, contextual transaction system 180 may discard the received location data and await additional data transmitted by client devices operating within environment 100 (e.g., in step 406). Exemplary process 400 may then be complete in step 408.

Alternatively, if the stored customer data were to include the unique identifier of user 101 or client device 102, contextual transaction system 180 may establish that user 101 represents a participating customer (e.g., step 404; YES), and contextual transaction system may store the received location data, which specifies the current geographic location of client device 102, within one or more tangible, non-transitory memories, such as within a portion of location database 184 (e.g., in step 410). Further, in step 412, contextual transaction system 180 may also obtain historical location data specifying a time-evolution of a geographic location of client device 102 over prior temporal intervals (e.g., as maintained within location database 184), and historical transaction data specifying and characterizing one or more prior transactions involving user 101 or initiated by client device 102 during these prior temporal intervals (e.g., as maintained within transaction database 186). As described herein, the prior temporal intervals may include, but are not limited to, a portion of a prior day (e.g., twelve hours), a prior day, a prior week, a prior month, a prior year, or any additional or alternate temporal interval appropriate to or established by the data maintained within location database 184 or transaction database 186.

Contextual transaction system 180 may perform any of the exemplary processes described herein to predict a future occurrence of a transaction involving user 101 and/or client device 102, and to determine expected values of parameters that characterize the predicted future occurrence of the transaction (e.g., in step 414). In some examples, the prediction of the future occurrence of the transaction, and the determination of the expected parameter values, by contextual transaction system 180 may be based on based on input data that includes, but is not limited to, the current geographic location of client device 102, the historical location data specifying a time-evolution of a geographic location of client device 102 over the prior temporal intervals, and the historical transaction data specifying and characterizing one or more prior transactions involving user 101 or initiated by client device 102 during these prior temporal intervals.

Further, and as described herein, contextual transaction system 180 may predict the future occurrence of the transaction and determine the expected parameter values in step 414 based on an application of one or more machine learning algorithms or processes to portions of the input data. Examples of the one or more machine learning algorithms include, but are not limited to, an association-rule algorithm (such as an Apriori algorithm, an Eclat algorithm, or an FP-growth algorithm), a clustering algorithm (such as a hierarchical clustering module, a k-means algorithm, or other statistical clustering algorithms), a collaborative filtering algorithm (such as a memory- or model-based algorithm), or an artificial intelligence algorithm (such as an artificial neural network). Further, one or more of the machine learning algorithms or the artificial intelligence algorithms may be trained against, and adaptively improved, using data characterizing prior geographic locations of other customers or devices operating within environment 100 (e.g., as maintained within location database 184), data characterizing transactions initiated by these other customers or devices during prior temporal intervals (e.g., as maintained within transaction database 186), and expected parameter values determined based on the data characterizing the prior geographic locations or initiated transactions. The disclosed embodiments are, however, not limited to these exemplary algorithms, and in other examples, contextual transaction system 180 may predict the future occurrence of the transaction and determine the expected parameter values using any additional or alternate algorithm appropriate to the input data described herein, such as, but not limited to, a rule- or preference-based algorithm, a statistical algorithm, or other artificial intelligence algorithms (e.g., an artificial algorithm that does not leverage machine or adaptive learning).

Referring back to FIG. 4, contextual transaction system 180 may perform any of the exemplary processes described herein to select a payment instrument that is held by user 101 and available to fund the future occurrence of the transaction in accordance with one or more rules or preferences associated with user 101, client device 102, and/or contextual transaction system 180 (e.g., in step 416). For example, contextual transaction system 180 may access and obtain stored data specifying and characterizing the one or more rules or preferences (e.g., portions rules and preference database 190 associated with the unique identifier of user 101 or client device 102), and access stored data identifying and characterizing one or more payment instruments held by user 101 and available to fund the predicted future occurrence of the transaction (e.g., portions of payment instrument database 188 associated with the unique identifier of user 101 or client device 102). Using any of the exemplary processes described above, contextual transaction system 180 may select, in step 416, one of the available payment instruments to fund the predicted future occurrence of the transaction based on an application of the one or more rules or preferences to the expected parameter values and to the data identifying and characterizing one or more available payment instruments.

In further examples, contextual transaction system 180 may perform any of the exemplary processes described herein to identify a tokenization system configured to generate a tokenized representation of the selected payment instrument, such as a digital token (e.g., in step 418). Further, and as described herein, contextual transaction system 180 may generate a token request that includes the unique identifier of client device 102 (such as the IP or MAC address) and data that identifies the selected payment instrument (such as the unique alphanumeric identifier of the portions of underlying account information), and may transmit the generated token request across network 120 to the identified tokenization system (e.g., in step 420). In some examples, as described herein, the identified tokenization system may generate a tokenized representation of the selected payment instrument (e.g., a digital token) in accordance with one or more payment or authorization protocols, such as the EMV payment protocol, and automatically provision the tokenized representation to client device 102 for use in the predicted future occurrence of the transaction. Exemplary process 400 is then complete in step 410.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification, including application programs 193, predictive engine 194, machine learning module 195, selection engine 196, initiation module 202, triggering module 212, authentication module 214, TSP module 232, routing modules 238, 250, 318, 320, 322, 338, and 352, management module 242, token generation module 244, provisioning module 248, local provisioning module 254, payment module 302, transaction initiation module 308, authentication request module 312, initiation module 326, token redemption module 330, authorization module 334, local authorization module 342, response generation module 348, transaction confirmation module 354, interface element generation module 356, and other application modules, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client device or computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a communications unit;
a storage unit storing instructions; and
at least one processor coupled to the communications unit and the storage unit, the at least one processor being configured to execute the instructions to:
receive a first signal via the communications unit, the first signal comprising first information identifying a current geographic location of a communications device;
based on the current geographic location, compute an expected value of a parameter of a second data exchange during a future temporal interval;
identify a data type for use in the second data exchange based on the expected parameter value; and
generate and transmit a second signal via the communications unit to a computing system associated with the identified data type, the second signal comprising second information instructing the computing system to provide a digital token representative of the identified data type to the communications device, the digital token being usable by the communications device to initiate the second data exchange during the future temporal interval.

2. The apparatus of claim 1, wherein the at least one processor is further configured to receive the first signal from the communications device.

3. The apparatus of claim 1, wherein:
the first signal comprises an identifier of the communications device; and
the at least one processor is further configured to load, from the storage unit, data characterizing at least one of (i) prior geographic locations of the communications device during a prior temporal interval; and (ii) first data exchanges involving the communications device during the prior temporal interval.

4. The apparatus of claim 3, wherein the at least one processor is further configured to compute the expected parameter value of the second data exchange based on the current geographic location of the communications device, the data characterizing the prior geographic locations of the communications device, and the data characterizing the first data exchanges involving the communications device.

5. The apparatus of claim 4, wherein:
the at least one processor is further configured to compute the expected parameter value of the second data exchange based on an application of a machine learning algorithm to the current geographic location of the communications device, the data characterizing the prior geographic locations of the communications device, and the data characterizing the first data exchanges involving the communications device; and
the machine learning algorithm comprises an association-rule machine learning algorithm, a clustering algorithm, a k-means algorithm, a collaborative filtering algorithm, an artificial intelligence algorithm, or an artificial neural network algorithm.

6. The apparatus of claim 1, wherein:
the first signal comprises an identifier of the communications device; and
the at least one processor is further configured to:
load, from the storage unit, data characterizing at least one of rule or a preference associated with the identifier of the communications device; and
identify the data type for use in the second data exchange based on an application of the at least one rule or preference to the expected parameter value.

7. The apparatus of claim 6, wherein the at least one processor is further configured to:
load, from the storage unit, data characterizing a plurality of candidate data types available for use in the second data exchange; and
establish one of the candidate data types as the identified data type based on an application of the at least one rule or preference to the expected parameter value and to the data characterizing a plurality of candidate data types.

8. The apparatus of claim 6, wherein the at least one processor is further configured to:
receive a third signal from the communications device via the communications unit, the third signal comprising a portion of the data characterizing the at least one rule or preference; and
associate the received portion of the data with the identifier of the communications device and store the received portion of the data within the storage unit.

9. The apparatus of claim 1, wherein the second information further instructs the computing system to generate the digital token in accordance with a data-exchange protocol.

10. The apparatus of claim 1, wherein:
the at least one processor is further configured to compute, based on the current geographic location, a plurality of expected parameter values that characterize the second data exchange;
a first one of the expected parameter values comprises an expected initiation time of the second data exchange, the expected initiation time being disposed within the second temporal interval; and
the second information further instructs the computing system to provide the digital token to the communications device prior to the expected initiation time.

11. A computer-implemented method, comprising:
receiving, by at least one processor, a first signal via a communications unit, the first signal comprising first information identifying a current geographic location of a communications device;
based on the current geographic location, computing, by the at least one processor, an expected value of a parameter of a second data exchange during a future temporal interval;
identifying, by the at least one processor, a data type for use in the second data exchange based on the expected parameter value; and
generating by the at least one processor and transmitting a second signal via the communications unit to a computing system associated with the identified data type, the second signal comprising second information instructing the computing system to provide a digital token representative of the identified data type to the communications device, the digital token being usable by the communications device to initiate the second data exchange during the future temporal interval.

12. The method of claim 11, further comprising receiving the first signal from the communications device.

13. The method of claim 11, wherein:
the first signal comprises an identifier of the communications device; and
the method further comprises:
based on the identifier of the communications device, loading, from a storage unit, data characterizing at least one of (i) prior geographic locations of the communications device during a prior temporal interval; and (ii) first data exchanges involving the communications device during the prior temporal interval; and
computing the expected parameter value of the second data exchange based on the current geographic location of the communications device, the data characterizing the prior geographic locations of the communications device, and the data characterizing the first data exchanges involving the communications device.

14. The method of claim 13, further comprising:
computing the expected parameter value of the second data exchange based on an application of a machine learning algorithm to the current geographic location of the communications device, the data characterizing the prior geographic locations of the communications device, and the data characterizing the first data exchanges involving the communications device; and
the machine learning algorithm comprises an association-rule machine learning algorithm, a clustering algorithm, a k-means algorithm, a collaborative filtering algorithm, an artificial intelligence algorithm, or an artificial neural network algorithm.

15. The method of claim 11, wherein:
the first signal comprises an identifier of the communications device; and
the method further comprises:
loading, from a storage unit, data characterizing at least one of rule or a preference associated with the identifier of the communications device; and
identifying the data type for use in the second data exchange based on an application of the at least one rule or preference to the expected parameter value.

16. The method of claim 15, further comprising:
loading, from the storage unit, data characterizing a plurality of candidate data types available for use in the second data exchange; and
establishing one of the candidate data types as the identified data type based on an application of the at least one rule or preference to the expected parameter value and to the data characterizing a plurality of candidate data types.

17. The method of claim 15, further comprising:
receive a third signal from the communications device via the communications unit, the third signal comprising a portion of the data characterizing the at least one rule or preference; and
associate the received portion of the data with the identifier of the communications device and store the received portion of the data within the storage unit.

18. The method of claim 11, wherein the second information further instructs the computing system to generate the digital token in accordance with a data-exchange protocol.

19. The method of claim 11, wherein:
the method further comprises computing, based on the current geographic location, a plurality of expected parameter values that characterize the second data exchange;
a first one of the expected parameter values comprises an expected initiation time of the second data exchange, the expected initiation time being disposed within the second temporal interval; and
the second information further instructs the computing system to provide the digital token to the communications device prior to the expected initiation time.

20. A tangible, non-transitory computer-readable medium storing instructions that, when executed by at least one processor, performs a method, the method comprising:
receiving a first signal via a communications unit, the first signal comprising first information identifying a current geographic location of a communications device;
based on the current geographic location, computing an expected value of a parameter of a second data exchange during a future temporal interval;
identifying a data type for use in the second data exchange based on the expected parameter value; and
generating and transmitting a second signal via the communications unit to a computing system associated with the identified data type, the second signal comprising second information instructing the computing system to provide a digital token representative of the identified data type to the communications device, the digital token being usable by the communications device to initiate the second data exchange during the future temporal interval.
